(19) United States
(12) Patent Application Publication
(10) Pub. No.: US 2014/0034307 A1
(43) Pub. Date: Feb. 6, 2014

(54) ENHANCED OIL RECOVERY METHODS USING A FLUID CONTAINING A SACRIFICIAL AGENT

(71) Applicant: Shell Oil Company, Houston, TX (US)

(72) Inventors: Jeffrey George SOUTHWICK, Houston, TX (US); Marten Marten BUIJSE, Rijswijk (NL); Diederik Willem VAN BATENBURG, Rijswijk (NL); Carolus Hendricus Theodorus VAN RIJN, Rijswijk (NL)

(21) Appl. No.: 13/957,041

(22) Filed: Aug. 1, 2013

Related U.S. Application Data
(60) Provisional application No. 61/679,182, filed on Aug. 3, 2012.

(51) Int. Cl. C09K 8/58; C09K 8/584; C09K 8/588; E21B 43/16

(52) U.S. Cl. CPC C09K 8/58; E21B 43/16; C09K 8/584; C09K 8/588
USPC 166/270.1; 166/52

(57) ABSTRACT

A method and a system for producing petroleum from a formation utilizing a sacrificial agent and a surfactant are provided. The sacrificial agent reduces the amount of surfactant required to enhance oil recovery from a petroleum-bearing formation. The sacrificial agent is provided in a sacrificial agent formulation comprising a sacrificial agent dispersed in a fluid. The sacrificial agent is selected from the group consisting of a compound comprising a single carboxylic acid, a single carboxylic acid derivative, or a single carboxylate salt, or a compound lacking a carboxylic acid group, a carboxylate group, a sulfonic acid group, or a sulfonate group that is a phenol, a sulphonamide, or a thiol, or a compound having a molecular weight of 1000 or less that comprises one or more hydroxyl groups. The sacrificial agent formulation is introduced into a petroleum-bearing formation followed by a surfactant and petroleum is produced therefrom.

This present application claims the benefit of U.S. Patent Application No. 61/679,182, filed Aug. 3, 2012.

### FIELD OF THE INVENTION

The present invention is directed to methods for recovering petroleum from a formation, and, in particular, the present invention is directed to methods of enhanced oil recovery using a surfactant.

### BACKGROUND OF THE INVENTION

Production of petroleum from a formation can be characterized by at least three different stages of production. During primary production, innate driving forces within the formation are sufficient to drive the petroleum from the formation, such as from the depths of a subterranean formation to the earth's surface. Innate driving forces may include natural pressure-generation mechanisms within the formation such as, for example, downward water displacement, natural gas expansion, and gravity-induced drainage within a well. At some point, the innate driving forces may decrease to such a degree that production significantly wanes or stops. In secondary production, an externally applied force may be supplied to the formation to provide sufficient energy to remove the petroleum therefrom. The externally applied force may include, for example, an injected fluid that creates fluid pressure that supplements or replaces that of the innate driving forces within the formation. External lifting mechanisms such as pumps may also be used to assist in production of the petroleum.

After secondary production no longer produces sufficient petroleum to be economically viable, there may, in many instances, still be substantial residual petroleum within the formation. Insufficient mobility of the petroleum within the formation may be one of the causes leading to its retention. Mobility of petroleum within a formation may be related to the innate viscosity of the petroleum, interfacial tension between the petroleum and water in the formation, surface interactions between the petroleum and the formation, combinations thereof, and the like. In tertiary production, also referred to as enhanced oil recovery, the mobility of petroleum within the formation is altered in some manner, thereby inducing mobilization and production of the petroleum to take place. Techniques for altering the mobility of the petroleum within the formation may include heating the petroleum to reduce its viscosity, introducing a miscible fluid such as carbon dioxide or a hydrocarbon to the petroleum to reduce its viscosity, or introducing a fluid containing a surfactant to the formation to reduce the interfacial tension between the petroleum and water in the formation and to reduce surface interaction of the petroleum and the formation. Although it was once conventional to conduct enhanced oil recovery techniques following the completion of primary and secondary production, it is now common to employ these techniques at any point during a production operation. That is, enhanced oil recovery techniques may be employed during primary or secondary production or as a separate production operation.

One problem that may be frequently encountered when lowering the interfacial tension within a formation using a surfactant is that of excessive surfactant sorption to the surface of the formation. As used herein, the term “sorption” collectively refers to absorption, adsorption, or any combination thereof. Excessive surfactant sorption to the formation may limit the surfactant's ability to reduce interfacial tension within a desired region of the formation. Although additional surfactant can be introduced to the formation to offset that rendered ineffective by sorption, such an approach may be undesirable from an economic standpoint, since many surfactants can be relatively costly. For at least this reason, it is ordinarily desirable to limit the amount of surfactant used during enhanced oil recovery production.

To address surfactant sorption within a formation, sacrificial agents may be used in conjunction with a surfactant. As used herein, the term “sacrificial agent” refers to a substance that mitigates the sorption of a surfactant to a formation or otherwise reduces the retention of the surfactant within the formation. Without limitation or being bound by theory or mechanism, the sacrificial agent may modify the surface of the formation or itself be sorbed to the formation such that sorption of the surfactant is reduced or eliminated. Ideally, the sacrificial agent is less costly than the surfactant, thereby allowing better process economics to be realized. Commonly used sacrificial agents may include, for example, inorganic salts, water-soluble polymer viscosifiers, lignosulfonates, cellulose and cellulose derivatives, starch and starch derivatives, and polybasic carboxylic acids, particularly chelating acids. Chelating acids may be particularly advantageous in this regard, since they may chelate metal ions, such as calcium and magnesium, that may react with surfactants and render them ineffective for reducing the interfacial tension within a formation.

### SUMMARY OF THE INVENTION

In one aspect, the present invention is directed to a method for producing oil, comprising:
providing a sacrificial agent formulation comprising a fluid and a sacrificial agent dispersed in the fluid, wherein the sacrificial agent is selected from the group consisting of a compound comprising a single carboxylic acid, a single carboxylic acid derivative, or a single carboxylate salt; a compound comprising a phenolic group, a thiol group, a sulfonamide group, or a salt thereof that lacks a carboxylic acid group or a salt thereof and lacks a sulfonic acid group or a salt thereof; a compound having a molecular weight of 1000 or less and comprising one or more hydroxyl groups; and mixtures thereof;
introducing the sacrificial agent formulation into a petroleum-bearing formation;
contacting the sacrificial agent formulation with the petroleum-bearing formation;
introducing an oil recovery formulation comprising a surfactant into the petroleum-bearing formation subsequent to introducing the sacrificial agent formulation into the formation;
contacting the oil recovery formulation with petroleum in the petroleum-bearing formation; and
producing petroleum from the petroleum-bearing formation after introducing the oil recovery formulation into the petroleum-bearing formation.

In another aspect, the present invention is a system, comprising:
a sacrificial agent formulation comprising a fluid and a sacrificial agent dispersed the fluid, wherein the sacrificial agent is selected from the group consisting of a compound comprising a single carboxylic acid, a single carboxylic acid derivative, or a single carboxylate salt; a compound comprising a phenolic group, a thiol group, a sulfonamide group, or a salt thereof that lacks a carboxylic acid group or a salt thereof and lacks a sulfonic acid group or a salt thereof; a compound having a molecular weight of 1000 or less and comprising one or more hydroxyl groups; and mixtures thereof;
an oil recovery formulation comprising a fluid and a surfactant dispersed in the fluid;
a petroleum-bearing formation;
a mechanism for introducing the sacrificial agent formulation into the petroleum-bearing formation;
a mechanism for introducing the oil recovery formulation into the petroleum-bearing formation subsequent to introduction of the sacrificial agent formulation into the formation; and
a mechanism for producing petroleum from the petroleum-bearing formation subsequent to introduction of the oil recovery formulation into the formation.

### BRIEF DESCRIPTION OF THE DRAWINGS

FIG. 1 is an illustration of a petroleum production system in accordance with the present invention.

FIG. 2 is a diagram of a well pattern for production of petroleum in accordance with a system and process of the present invention.

FIG. 3 is a diagram of a well pattern for production of petroleum in accordance with a system and process of the present invention.

FIGS. 4 and 5 respectively show illustrative retention plots of surfactant after a core pre-flush of erythorbic acid.

FIG. 6 shows an illustrative retention plot of surfactant observed after a core pre-flush that did not include erythorbic acid.

### DETAILED DESCRIPTION OF THE INVENTION

The present invention is directed to methods for recovering petroleum from a formation, and, in particular, the present invention is directed to methods of enhanced oil recovery using a surfactant. More specifically, the present invention is directed to methods of enhanced oil recovery using an oil recovery formulation comprising a surfactant where a sacrificial agent formulation is introduced into a formation prior to introducing the oil recovery formulation into the formation to inhibit or prevent sorption of the surfactant to the formation, where the sacrificial agent formulation comprises a fluid with a sacrificial agent dispersed therein. The sacrificial agent may be a compound comprising a single carboxylic acid, a single carboxylic acid derivative, or a single carboxylate salt; or an acidic compound or salt thereof that lacks a carboxylic acid, sulfonic acid, or a salt thereof; or a compound having a molecular weight of about 1000 or less and having one or more hydroxyl groups.

As discussed above, a number of different types of sacrificial agents have been used in conjunction with the introduction of surfactants to a petroleum-bearing formation, particularly during enhanced oil recovery operations. Although these sacrificial agents have been used with varying degrees of success, the discovery and development of new sacrificial agents is desirable to increase operational flexibility for a given application, to reduce costs associated with the surfactant and/or the sacrificial agent, and/or to increase the amount of petroleum produced from the formation.

When a petroleum-bearing formation is in its native environment (e.g., in a subterranean formation), the formation may be in a reduced state. When a portion of a formation is removed from its native environment, for example a core sample obtained from the formation for oil recovery studies, oxidation may occur, thereby changing the oxidative state of the core sample and its properties. To return the core sample to a reduced state that may be more like that natively present within a subterranean formation, the core sample may be treated with a reducing agent before conducting testing thereon. Sodium dithionite is often used for this purpose.

In enhanced oil recovery operations, an oil recovery formulation containing a polymer and a surfactant may be utilized to enhance oil recovery from a formation. An alkali may often be present as well. These two types of enhanced oil recovery operations are commonly referred to as surfactant-polymer (SP) and alkali-surfactant-polymer (ASP) floods, respectively. In the process of testing an ASP flood on a sodium dithionite-reduced core sample, polymer degradation was observed, which was believed to be promoted by the sodium dithionite. Accordingly, the core sample reduction was conducted using erythorbic acid, which is a milder reducing agent, followed by an ASP core flood. Surprisingly, treatment of the core sample with erythorbic acid significantly decreased retention of the surfactant within the core sample. Although providing the desired core reduction, sodium dithionite, in contrast, did not significantly impact retention of the surfactant within the core sample.

The present invention is directed to a process and a system for enhanced oil recovery from a petroleum-bearing formation. A sacrificial agent formulation as described above is introduced into a petroleum-bearing formation and contacted with the formation. In a preferred embodiment, the sacrificial agent formulation comprises erythorbic acid. An oil recovery formulation comprising a fluid and a surfactant dispersed in the fluid is introduced into the petroleum-bearing formation after introducing the sacrificial agent formulation into the formation and contacting the sacrificial agent formulation with the formation. The oil recovery formulation is contacted with petroleum in the petroleum-bearing formation. After introducing the oil recovery formulation into the petroleum-bearing formation, petroleum is produced from the formation. At least a portion of the oil recovery formulation introduced into the formation comprising at least a portion of the surfactant may be produced from the formation.

The sacrificial agent formulation composition comprises a sacrificial agent having one or more chemical structural attributes of erythorbic acid. The structure of erythorbic acid is shown below in Formula 1. Erythorbic acid is an enantiomer of ascorbic acid, also known as Vitamin C, which shown in Formula 2, and ascorbic acid may function as a sacrificial agent in a like manner to erythorbic acid.

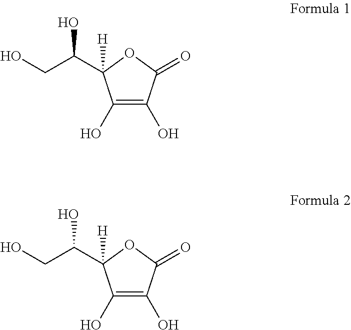 [SMILES: O=C1O[C@H]([C@H](O)CO)C(O)=C1O ; O=C1O[C@H]([C@@H](O)CO)C(O)=C1O]

As putative sacrificial agents, erythorbic acid and ascorbic acid contain several chemical structural features, any of which, separately or together, may contribute to a surprising decrease of surfactant retention within a formation to which the sacrificial agent formulation has been introduced. Erythorbic acid and ascorbic acid contain both neutral alcohol-type hydroxyl groups and enol-type hydroxyl groups, the latter of which confer acidity to the compounds. Erythorbic acid and ascorbic acid also contain considerably fewer hydroxyl groups than polysaccharide- and starch-based sacrificial agents that have been previously used in the art. The enol-type hydroxyl groups of erythorbic and ascorbic acids' reductone structures may also be readily oxidized to a diketone, thereby allowing erythorbic acid and ascorbic acid to function as mild reducing agents. The oxidation products of erythorbic acid and ascorbic acid—dehydroerythorbic acid and dehydroascorbic acid, respectively—may also play a role in decreasing surfactant retention within a petroleum-bearing formation. These compounds are shown in Formulas 3 and 4, respectively. In addition, erythorbic acid and ascorbic acid may undergo lactone hydrolysis under formation temperature and pressure conditions within a petroleum-bearing formation to liberate a free carboxylic acid, which may also contribute to reducing surfactant retention within the formation.

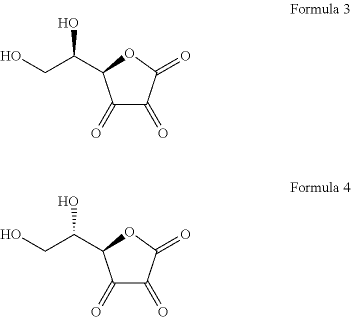 [SMILES: O=C1O[C@H]([C@H](O)CO)C(=O)C1=O ; O=C1O[C@H]([C@@H](O)CO)C(=O)C1=O]

In addition to the above features, erythorbic acid and ascorbic acid may form weakly bound chelates with metals. Without being bound by theory or mechanism, it is believed that chelation of the sacrificial agent to a formation surface to permanently block a potential surfactant binding site may play only a minor role in their function as sacrificial agents, given their fairly weak chelation properties, although weak chelation of the sacrificial agent with the formation surface may inhibit binding of a surfactant to the formation surface for the period of time until the sacrificial agent releases from the formation surface. It is believed that erythorbic acid and ascorbic acid may be distinguished from polybasic carboxylic acid chelation agents since they lack a free carboxylic acid group for metal ion chelation. Even in their hydrolyzed form, they still lack a second carboxylic acid group needed for strong metal chelation to take place.

In one aspect, the sacrificial agent of the sacrificial agent formulation may comprise a compound comprising a single carboxylic acid group, a single carboxylic acid derivative group, or a single carboxylate salt group. As used herein, the term “carboxylic acid derivative” refers to a compound containing a reaction product of a carboxylic acid group that does not retain a free carboxylic acid hydroxyl group. Illustrative carboxylic acid derivatives include esters and amides, which may be lactones or lactams. The sacrificial agent compound containing a single carboxylic acid group, a single carboxylic acid derivative group, or a single carboxylate salt group may also contain one or more hydroxyl groups.

The sacrificial agent of the sacrificial agent formulation may comprise a monocarboxylic acid compound or a salt thereof. As used herein, the term “monocarboxylic acid compound” refers to a compound containing only one carboxylic acid group or carboxylate group. The monocarboxylic acid compound of the sacrificial agent may be a hydrocarbon comprising 10 carbons or fewer, or 9 carbons or fewer, or 8 carbons or fewer, or 7 carbons or fewer, or 6 carbons or fewer, or 5 carbons or fewer. The monocarboxylic acid compound may contain from 2-10 carbons, or from 3-9 carbons, or from 4-8 carbons. The monocarboxylic acid compound may comprise a straight carbon chain or may comprise a branched carbon chain. The monocarboxycylic acid compound may comprise a non-aromatic cyclic carbon ring, optionally with branching, or may comprise an aromatic ring, optionally with branching. The carbon chain or ring may contain one or more heteroatoms selected from the group consisting of oxygen, nitrogen, and sulfur within the chain or ring.

The monocarboxylic acid compound of the sacrificial agent may be a hydroxycarboxylic acid compound comprising one or more hydroxyl groups. The hydroxycarboxylic acid compound may comprise a straight carbon chain or a branched carbon chain. The hydroxycarboxylic acid compound may comprise a non-aromatic cyclic carbon ring or an aromatic cyclic carbon ring, optionally with branching. The carbon chain or ring may comprise one or more heteroatoms selected from the group consisting of oxygen, sulfur, and nitrogen within the chain or ring. Hydroxycarboxylic acid compounds suitable for use as a sacrificial agent compound of the sacrificial agent formulation may include from 1 to 10 hydroxyl groups, or from 1 to 6 hydroxyl groups, or from 1 to 3 hydroxyl groups. The sacrificial agent may comprise a compound that is a monohydroxycarboxylic acid, a dihydroxycarboxylic acid, a trihydroxycarboxylic acid, a tetrahydroxycarboxylic acid, a pentahydroxycarboxylic acid, a salt thereof, or any combination thereof. The sacrificial agent may comprise a compound that is an α-hydroxycarboxylic acid, a β-hydroxycarboxylic acid, a γ-hydroxycarboxylic acid, a δ-hydroxycarboxylic acid, an ε-hydroxycarboxylic acid, a salt thereof, or any combination thereof.

The sacrificial agent of the sacrificial agent formulation may comprise a compound comprising an enol or that is enolizable, including stabilized enols. In some embodiments, the enol may only form as a transient tautomer where the enol may not persist as an abundant and observable species. As used herein, the term “stabilized enol” refers to a compound containing a hydroxyl group bound to a doubly-bonded carbon in which at least some of the enol tautomer persists as an abundant and observable species. Compounds such as β-diketones, β-ketoesters, and some acyloins may produce a stabilized enol. Reductones are another class of compounds that may produce a stabilized enol. As used herein, the term “reductone” refers to a compound having an enediol functionality located adjacent to a carbonyl group. Suitable reductone compounds may be straight chain, branched, or cyclic. Reductone compounds that may be used as the sacrificial agent or a portion thereof may have a structure as defined by Formula 5 below, wherein R₁ and R₂ comprise a carbon-containing group having between 1 and 10 carbon atoms and R₁ and R₂ are the same or different. Reductone compounds that may be used as the sacrificial agent or a portion thereof may have a structure as defined by Formula 6 below, wherein Z is O, NR₃, or CR₄R₅ and A comprises a divalent carbon-containing group having between 1 and 10 carbon atoms. R₃ may be selected from H and a carbon-containing group having between 1 and 10 carbon atoms, and R₄ and R₅ are independently selected from H and a carbon containing group having between 1 and 10 carbon atoms. The sacrificial agent may comprise a reductone selected from the group consisting of erythorbic acid, ascorbic acid, reductic acid (A=CH₂ and Z═CH₂), a salt thereof, and any combination thereof.

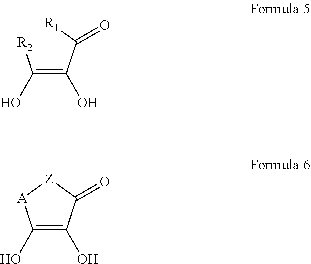

In another aspect, the sacrificial agent of the sacrificial agent formulation may be a compound that is acidic or is a salt thereof where the compound lacks a carboxylic acid group, a sulfonic acid group, a carboxylate salt group, or a sulfonate salt group. Such acidic compounds and salts thereof include phenols, sulfonamides, and thiols.

In a further aspect, the sacrificial agent formulation may comprise a sacrificial agent wherein the sacrificial agent comprises a compound having a molecular weight of about 1000 or less comprising one or more hydroxyl groups. The sacrificial agent may comprise a compound having one or more hydroxyl groups and having a molecular weight of 500 or less, or 300 or less, or 200 or less. The sacrificial agent may comprise a compound containing only one hydroxyl group, or containing only two hydroxyl groups, or containing only three hydroxyl groups, or containing only four hydroxyl groups, or containing only five hydroxyl groups, or containing only six hydroxyl groups. At least a portion of the hydroxyl groups in a sacrificial agent compound containing hydroxyl groups may be enolic hydroxyl groups.

The sacrificial agent may be comprised of a carbohydrate. Suitable carbohydrates include monosaccharides and low molecular weight oligosaccharides having a molecular weight of 1000 or less. The sacrificial agent may comprise a compound selected from the group consisting of a monosaccharide, a disaccharide, a trisaccharide, a tetrasaccharide, a pentasaccharide, and any combination thereof. The carbohydrate may comprise at least one reducing sugar or a derivative thereof. Suitable reducing sugars include, but are not limited to, glucose, glyceraldehyde, galactose, lactose, maltose, and fructose.

In another aspect, the sacrificial agent formulation may comprise a sacrificial agent that is a compound comprising an oxidizable functional group. In some embodiments, the sacrificial agent compound may be a “reducing acid”, a salt thereof, or a derivative thereof. As used herein, a “reducing acid” refers to an acidic compound, a salt thereof, or a derivative thereof including esters, lactones, amides, and lactams, that contains a functional group that may undergo oxidation. The sacrificial agent formulation may comprise two or more sacrificial agent compounds wherein the compounds are a combination of an oxidizable compound and its oxidation product(s), for example, a combination of erythorbic acid and dehydroerythorbic acid, salts, and derivatives thereof, or a combination of ascorbic acid and dehydroascorbic acid, salts, and derivatives thereof. In embodiments in which one or more of the sacrificial agent compounds comprise an oxidizable functional group, the methods described herein may further comprise oxidizing the sacrificial agent compound(s) after contacting the sacrificial agent formulation with the formation.

The sacrificial agent formulation further comprises a fluid in which the sacrificial agent is dispersed. The fluid may be an aqueous fluid. The fluid may be water. The fluid may be an aqueous brine. The fluid may be comprised of water and a co-solvent. The co-solvent may be a water miscible organic solvent including water miscible alcohols, glycols, aldehydes, and ketones. The co-solvent may be methanol, ethanol, isopropanol, ethylene glycol, acetone, or a combination thereof. In a preferred embodiment, the fluid may be an aqueous brine produced from the petroleum-bearing formation or may be water with added salts formulated to have a salt composition similar to the aqueous formation brine.

The sacrificial agent may comprise from 0.001 wt. % to 5 wt. % of the sacrificial agent formulation, with the balance of the formulation being the aqueous fluid. The concentration of the sacrificial agent in the sacrificial agent formulation may range from 0.001 wt. % to 5 wt. %, or from 0.005 wt. % to 1 wt. %, or from 0.01 wt. % to 0.5 wt. %, or from 0.05 wt. % to 0.1 wt. % of the sacrificial agent formulation.

The oil recovery formulation introduced into the petroleum-bearing formation after introduction of the sacrificial agent formulation into the formation comprises a surfactant. The surfactant may an anionic surfactant. The anionic surfactant may be a sulfonate-containing compound, a sulfate-containing compound, a carboxylate compound, a phosphate compound, or a blend thereof. The anionic surfactant may be an alpha olefin sulfonate compound, an internal olefin sulfonate compound, a branched alkyl benzene sulfonate compound, a propylene oxide sulfate compound, an ethylene oxide sulfate compound, an ethylene oxide-propylene oxide sulfate compound, or a blend thereof. The anionic surfactant may contain from 12 to 30 carbons, or from 12 to 20 carbons. The surfactant of the oil recovery formulation may comprise an internal olefin sulfonate compound containing from 15 to 18 carbons or a propylene oxide sulfate compound containing from 12 to 15 carbons, or a blend thereof, where the blend may contain a volume ratio of the propylene oxide sulfate to the internal olefin sulfonate compound of from 1:1 to 10:1.

The oil recovery formulation further comprises a fluid in which the surfactant is dispersed. The fluid may be water or an aqueous brine, and the oil recovery formulation may be an aqueous dispersion or solution of the surfactant. The fluid may be comprised of water and a co-solvent. The co-solvent may be a water miscible organic solvent including water miscible alcohols, glycols, aldehydes, and ketones. The co-solvent may be methanol, ethanol, isopropanol, isobutyl alcohol, secondary butyl alcohol, n-butyl alcohol, t-butyl alcohol, diethylene glycol butyl ether (DGBE), triethylene glycol butyl ether (TEGBE), sodium dihexyl sulfosuccinate (MA-80), ethylene glycol, acetone, or a combination thereof.

The fluid of the oil recovery formulation may be an aqueous brine solution derived from the petroleum-bearing formation or formulated to have a salt composition similar to an aqueous formation brine. The fluid of the oil recovery formulation may be a fluid having substantially similar, or the same, composition as the fluid of the sacrificial agent formulation. In a preferred embodiment, the fluid of the oil recovery formulation is an aqueous brine solution produced from the petroleum-bearing formation.

The concentration of the surfactant in the oil recovery formulation may range from 0.05 wt. % to 5 wt % of the oil recovery formulation. The concentration of the surfactant in the oil recovery formulation may range from 0.1 wt. % to 3 wt. % or from 0.2 wt % to 1 wt. %, or from 0.3 wt. % to 0.7 wt. % of the oil recovery formulation.

The oil recovery formulation comprising the surfactant and the fluid may further comprise a polymer dispersable in the fluid, and preferably soluble in the fluid. The oil recovery formulation comprising the surfactant, the fluid, and the polymer may further comprise an alkali as an aid for dispersing the polymer in the fluid.

The oil recovery formulation may comprise a polymer selected from the group consisting of polyacrylamides, partially hydrolyzed polyacrylamides, polyacrylates, ethylenic co-polymers, biopolymers, carboxymethylcelloluses, polyvinyl alcohols, polystyrene sulfonates, polyvinylpyrrolidones, AMPS (2-acrylamide-methyl propane sulfonate), and combinations thereof. Examples of ethylenic co-polymers include co-polymers of acrylic acid and acrylamide, acrylic acid and lauryl acrylate, and lauryl acrylate and acrylamide. Examples of biopolymers include xanthan gum, guar gum, alginic acid, and alginate salts.

The quantity of polymer in the oil recovery formulation, if any, should be sufficient to drive a mixture of the oil recovery formulation and petroleum through a petroleum bearing formation. The quantity of the polymer in the oil recovery formulation may be sufficient to provide the oil recovery formulation with a dynamic viscosity at formation temperatures on the same order of magnitude, or a greater order of magnitude, as the dynamic viscosity of petroleum in the petroleum-bearing formation to which the oil recovery formulation is introduced at formation temperatures so the oil recovery formulation may push a mixture of oil recovery formulation and petroleum through the formation. The quantity of the polymer in the oil recovery formulation may be sufficient to provide the oil recovery formulation with a dynamic viscosity of at least 10 mPa s (10 cP), or at least 100 mPa s (100 cP), or at least 500 mPa s (500 cP), or at least 1000 mPa s (1000 cP) at 25° C. or at a temperature within a formation temperature range. The concentration of polymer in the oil recovery formulation may be from 250 ppm to 5000 ppm, or from 500 ppm to 2500 ppm, or from 1000 to 2000 ppm.

The molecular weight average of the polymer in the oil recovery formulation should be sufficient to provide sufficient viscosity to the oil recovery formulation to drive petroleum or a mixture of petroleum and the oil recovery formulation through the formation. The polymer may have a molecular weight average of at least 10000 daltons, or at least 50000 daltons, or at least 100000 daltons. The polymer may have a molecular weight average of from 10000 to 20000000 daltons, or from 100000 to 1000000 daltons.

As described above, the oil recovery formulation may further comprise an alkali. The alkali may be an alkali metal base or an alkali metal salt. Suitable alkali metal bases and salts include lithium hydroxide, sodium hydroxide, potassium hydroxide, lithium carbonate, sodium carbonate, potassium carbonate, lithium bicarbonate, sodium bicarbonate, potassium bicarbonate, lithium silicate, lithium phosphate, sodium silicate, sodium phosphate, potassium silicate, and potassium phosphate. The oil recovery formulation may comprise from 0.001 wt. % to 5 wt. % of the alkali, or from 0.005 wt. % to 1 wt. % of the alkali, or from 0.01 wt. % to 0.5 wt. % of the alkali.

In the method of the present invention the sacrificial agent formulation and the oil recovery formulation are introduced into a petroleum-bearing formation, and the system of the present invention includes a petroleum-bearing formation. The petroleum-bearing formation comprises petroleum that may be separated and produced from the formation after contact and mixing with the oil recovery formulation. The petroleum of the petroleum-bearing formation may be a heavy oil containing at least 25 wt. %, or at least 30 wt. %, or at least 35 wt. %, or at least 40 wt. % of hydrocarbons having a boiling point of at least 538° C. (1000° F.) as determined in accordance with ASTM Method D5307. The heavy oil may have an asphaltene content of at least at least 5 wt. %, or at least 10 wt. %, or at least 15 wt. %, where “asphaltene” as used herein refers to a hydrocarbon compound that is insoluble in n-heptane and in soluble in toluene. Alternatively, the petroleum contained in the petroleum-bearing formation may be an intermediate weight oil or a relatively light oil containing less than 25 wt. %, or less than 20 wt. %, or less than 15 wt. %, or less than 10 wt. %, or less than 5 wt. % of hydrocarbons having a boiling point of at least 538° C. (1000° F.). The intermediate weight oil or light oil may have an asphaltene content of less than 5 wt. %.

The petroleum contained in the petroleum-bearing formation may have a dynamic viscosity under formation conditions (in particular, at temperatures within the temperature range of the formation) or at 25° C. of at least 1 mPa s (1 cP), or at least 10 mPa s (10 cP), or at least 100 mPa s (100 cP), or at least 1000 mPa s (1000 cP), or at least 10000 mPa s (10000 cP). The petroleum contained in the petroleum-bearing formation may have a dynamic viscosity under formation temperature conditions of from 1 to 10000000 mPa s (1 to 10000000 cP).

The petroleum-bearing formation may be a subterranean formation. The subterranean formation may be comprised of one or more porous matrix materials selected from the group consisting of a porous mineral matrix, a porous rock matrix, and a combination of a porous mineral matrix and a porous rock matrix, where the porous matrix material may be located beneath an overburden at a depth ranging from 50 meters to 6000 meters, or from 100 meters to 4000 meters, or from 200 meters to 2000 meters under the earth's surface. The subterranean formation may be a subsea subterreanan formation.

The porous matrix material may be a consolidated matrix material in which at least a majority, and preferably substantially all, of the rock and/or mineral that forms the matrix material is consolidated such that the rock and/or mineral forms a mass in which substantially all of the rock and/or mineral is immobile when petroleum, the sacrificial agent formulation, the oil recovery formulation, water, or other fluid is passed therethrough. Preferably at least 95 wt. % or at least 97 wt. %, or at least 99 wt. % of the rock and/or mineral is immobile when petroleum, the sacrificial agent formulation, the oil recovery formulation, water, or other fluid is passed therethrough so that any amount of rock or mineral material dislodged by the passage of the petroleum, sacrificial agent formulation, oil recovery formulation, water, or other fluid is insufficient to render the formation impermeable to the flow of the sacrificial agent formulation, oil recovery formulation, petroleum, water, or other fluid through the formation. The porous matrix material may be an unconsolidated matrix material in which at least a majority, or substantially all, of the rock and/or mineral that forms the matrix material is unconsolidated. The formation may have a permeability of from 0.00001 to 15 Darcies, or from 0.001 to 1 Darcy. The rock and/or mineral porous matrix material of the formation may be comprised of sandstone and/or a carbonate selected from dolomite, limestone, and mixtures thereof—where the limestone may be microcrystalline or crystalline limestone and/or chalk.

Petroleum in the petroleum-bearing formation may be located in pores within the porous matrix material of the formation. The petroleum in the petroleum-bearing formation may be immobilized in the pores within the porous matrix material of the formation, for example, by capillary forces, by interaction of the petroleum with the pore surfaces, by the viscosity of the petroleum, or by interfacial tension between the petroleum and water in the formation.

The petroleum-bearing formation may also be comprised of water, which may be located in pores within the porous matrix material. The water in the formation may be connate water, water from a secondary or tertiary oil recovery process water-flood, or a mixture thereof. The water in the petroleum-bearing formation may be positioned to immobilize petroleum within the pores. Contact of the oil recovery formulation with the petroleum in the formation may mobilize the petroleum in the formation for production and recovery from the formation by freeing at least a portion of the petroleum from pores within the formation.

In some embodiments, the petroleum-bearing formation may comprise unconsolidated sand and water. The petroleum-bearing formation may be an oil sand formation. In some embodiments, the petroleum may comprise between about 1 wt. % and about 16 wt. % of the oil/sand/water mixture, the sand may comprise between about 80 wt. % and about 85 wt. % of the oil/sand/water mixture, and the water may comprise between about 1 wt. % and about 16 wt. % of the oil/sand water mixture. The sand may be coated with a layer of water with the petroleum being located in the void space around the wetted sand grains. Optionally, the petroleum-bearing formation may also include a gas, such as methane or air, for example.

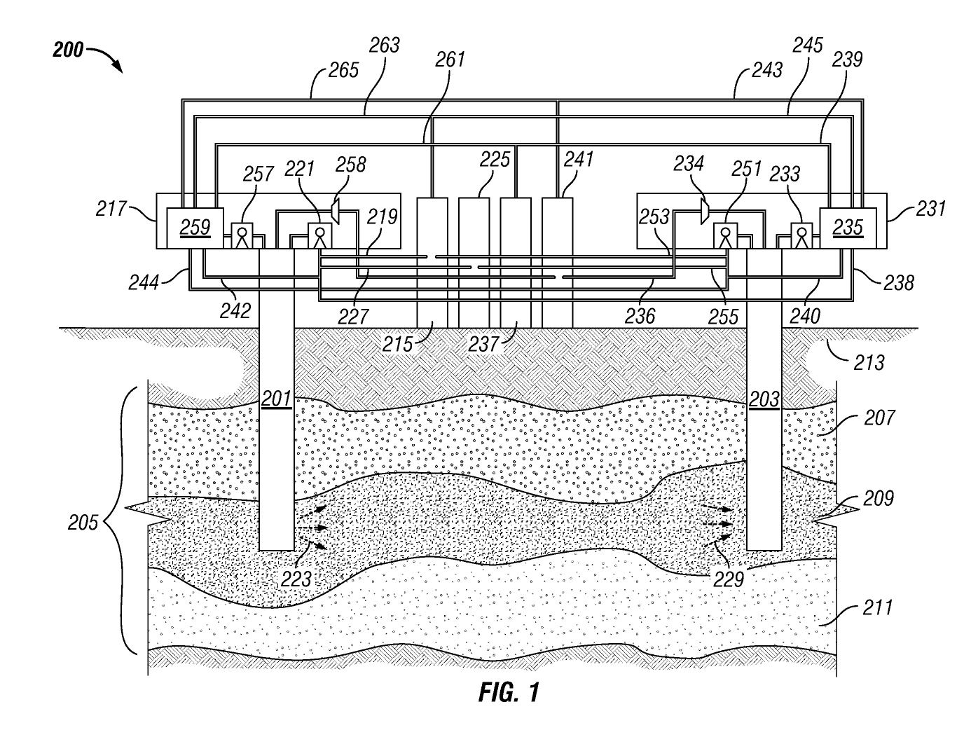

Referring now to FIG. 1, a system 200 of the present invention for practicing a method of the present invention is shown. The system includes a first well 201 and a second well 203 extending into a petroleum-bearing formation 205 such as described above. The petroleum-bearing formation 205 may be comprised of one or more formation portions 207, 209, and 211 formed of porous material matricies, such as described above, located beneath an overburden 213.

A sacrificial agent formulation comprising a sacrificial agent and a fluid in which the sacrificial agent is dispersed as described above is provided. The sacrificial agent formulation may be provided from a sacrificial agent storage facility 225 fluidly operatively coupled to a first injection/production facility 217 via conduit 227. First injection/production facility 217 may be fluidly operatively coupled to the first well 201, which may be located extending from the first injection/production facility 217 into the petroleum-bearing formation 205. The sacrificial agent formulation may flow from the first injection/production facility 217 through the first well 201 to be introduced into the formation, for example in formation portion 209, where the first injection/production facility 217 and the first well, or the first well itself, include(s) a mechanism for introducing the sacrificial agent into the formation. Alternatively, the sacrificial agent formulation may flow from the sacrificial agent formulation storage facility 225 directly to the first well 201 for injection into the formation 205, where the first well comprises a mechanism for introducing the sacrificial agent formulation into the formation. The mechanism for introducing the sacrificial agent formulation into the formation 205 via the first well 201—located in the first injection/production facility 217, the first well 201, or both—may be comprised of a pump 221 for delivering the sacrificial agent formulation to perforations or openings in the first well through which the sacrificial agent formulation may be introduced into the formation.

The sacrificial agent formulation may be introduced into the formation 205, for example by injecting the sacrificial agent formulation into the formation through the first well 201 by pumping the sacrificial agent formulation through the first well and into the formation. The pressure at which the sacrificial formulation may be introduced into the formation may range from the instantaneous pressure in the formation up to, but not including, the fracture pressure of the formation. The pressure at which the sacrificial agent formulation may be injected into the formation may range from 20% to 95%, or from 40% to 90%, of the fracture pressure of the formation. Alternatively, the pressure at which the sacrificial agent formulation may be injected into the formation may be a pressure of at least the fracture pressure of the formation.

The volume of sacrificial agent formulation introduced into the formation 205 via the first well 201 may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the sacrificial agent formulation or the oil recovery formulation between the first well 201 and the second well 203. The pore volume may be readily be determined by methods known to a person skilled in the art, for example by modelling studies or by injecting water having a tracer contained therein through the formation 205 from the first well 201 to the second well 203.

As the sacrificial agent formulation is introduced into the formation 205, the sacrificial agent formulation spreads into the formation as shown by arrows 223. Upon introduction to the formation 205, the sacrificial agent in the sacrificial agent formulation may interact with the formation, the water in the formation, petroleum in the formation and/or any surfactant in the formation to inhibit loss of surfactant within the formation. The sacrificial agent may temporarily or permanently bind to surfaces within the formation, for example to mineral or rock surfaces within the formation, and/or the sacrificial agent may temporarily or permanently bind to ions, preferably divalent cations, in the water within the formation to inhibit or prevent the loss of the surfactant within the formation.

After introduction of the sacrificial agent formulation into the formation 205, an oil recovery formulation containing a surfactant is introduced into the formation to enhance petroleum recovery from the formation. The oil recovery formulation comprising a fluid, preferably water or an aqueous brine, and a surfactant, as described above, and optionally comprising a polymer and/or an alkali as described above, may be provided from an oil recovery formulation storage facility 215 fluidly operatively coupled to the first injection/production facility 217 via conduit 219. The oil recovery formulation may flow from the first injection/production facility 217 through the first well to be introduced into the formation 205 at a location within the formation at or near the location at which the sacrificial agent formulation was introduced into the formation. The first injection/production facility 217 and the first well, or the first well itself, may include a mechanism for introducing the oil recovery formulation into the formation. Alternatively, the oil recovery formulation may flow from the oil recovery formulation storage facility 215 directly to the first well 201 for injection into the formation 205, where the first well comprises a mechanism for introducing the oil recovery formulation into the formation. The mechanism for introducing the oil recovery formulation into the formation 205 via the first well 201—located in the first injection/production facility 217, the first well 201, or both—may be the pump 221, which may deliver the oil recovery formulation to perforations or openings in the first well at or near the location that the sacrificial agent formulation was introduced into the formation through which the oil recovery formulation may be introduced into the formation.

The oil recovery formulation may be introduced into the formation 205, for example by injecting the oil recovery formulation into the formation through the first well 201 by pumping the oil recovery formulation through the first well and into the formation. The pressure at which the oil recovery formulation may be introduced into the formation may range from the instantaneous pressure in the formation up to, but not including, the fracture pressure of the formation. The pressure at which the oil recovery formulation may be injected into the formation may range from 20% to 95%, or from 40% to 90%, of the fracture pressure of the formation. Alternatively, the pressure at which the oil recovery formulation may be injected into the formation may be at least the fracture pressure of the formation.

The volume of oil recovery formulation introduced into the formation 205 via the first well 201 may range from 0.001 to 5 pore volumes, or from 0.01 to 2 pore volumes, or from 0.1 to 1 pore volumes, or from 0.2 to 0.6 pore volumes, as defined above.

As the oil recovery formulation is introduced into the formation 205, the oil recovery formulation spreads into the formation as shown by arrows 223. Upon introduction to the formation 205, the oil recovery formulation contacts and forms a mixture with a portion of the petroleum in the formation, and may encounter the sacrificial agent. The oil recovery formulation may mobilize the petroleum in the formation upon contacting and mixing with the petroleum and water in the formation. The oil recovery formulation may mobilize the petroleum in the formation upon contacting and mixing with the petroleum, for example, by reducing capillary forces retaining the petroleum in pores in the formation, by reducing the wettability of the petroleum on pore surfaces in the formation, by reducing the interfacial tension between petroleum and water in the formation, and/or by forming a microemulsion with petroleum and water in the formation.

Upon introduction of the oil recovery formulation into the formation, the sacrificial agent may interact with the formation, the water in the formation, petroleum in the formation and/or the surfactant to inhibit loss of the surfactant within the formation. The sacrificial agent may temporarily or permanently bind to surfaces within the formation, for example to mineral or rock surfaces within the formation, and/or the sacrificial agent may temporarily or permanently bind to ions, preferably divalent cations, in the water within the formation to inhibit or prevent the loss of the surfactant within the formation.

The mobilized mixture of the oil recovery formulation and petroleum, any unmixed oil recovery formulation, and the sacrificial agent formulation may be pushed across the formation 205 from the first well 201 to the second well 203 by further introduction of more oil recovery formulation into the formation. The oil recovery formulation may be designed to displace the mobilized mixture of the oil recovery formulation, petroleum, and sacrificial agent formulation through the formation for production at the second well 203. As described above, the oil recovery formulation may contain a polymer, wherein the oil recovery formulation comprising the polymer may have a viscosity of at least the same order of magnitude as the viscosity of the petroleum in the formation under formation temperature conditions, and preferably at least one order of magnitude greater than the viscosity of the petroleum in the formation at formation temperature conditions, so the oil recovery formulation may drive the mobilized mixture of oil recovery formulation and petroleum across the formation while inhibiting fingering of the mobilized petroleum/oil recovery formulation through the driving plug of oil recovery formulation.

Petroleum may be mobilized for production from the formation 205 via the second well 203 by introduction of the oil recovery formulation into the formation, where the mobilized petroleum is driven through the formation for production from the second well as indicated by arrows 229 by introduction of the oil recovery formulation into the formation via the first well 201. The petroleum mobilized for production from the formation 205 may include the mobilized petroleum/oil recovery formulation mixture and optionally at least a portion of the sacrificial agent formulation. Water and/or gas may also be mobilized for production from the formation 205 via the second well 203 by introduction of the oil recovery formulation into the formation via the first well 201.

After introduction of the oil recovery formulation into the formation 205 via the first well 201, petroleum may be recovered and produced from the formation via the second well 203. The oil recovery formulation, or a portion thereof, and the sacrificial agent formulation, or a portion thereof, may also be produced and recovered from the formation, optionally in conjunction with the petroleum. Portions of the oil recovery formulation may be recovered separately from other portions of the oil recovery formulation. For example, the surfactant of the oil recovery formulation may be recovered separately from the fluid of the oil recovery formulation, for example, the surfactant may be recovered in the petroleum produced from the formation and not in water that formed a portion of the oil recovery formulation Likewise, portions of the sacrificial agent formulation may be recovered separately from other portions of the sacrificial agent.

The system of the present invention may include a mechanism located at the second well for producing and recovering the petroleum from the formation 205 subsequent to introduction of the oil recovery formulation into the formation, and may include a mechanism located at the second well for producing the oil recovery formulation or a portion thereof, the sacrificial agent formulation or a portion thereof, and/or gas from the formation subsequent to introduction of the oil recovery formulation into the formation. The mechanism located at the second well 203 for recovering and producing the petroleum, and optionally for recovering and producing the oil recovery formulation, or a portion thereof, the sacrificial agent formulation, or a portion thereof, and/or gas may be comprised of a pump 233, which may be located in a second injection/production facility 231 and/or within the second well 203. The pump 233 may draw the petroleum, and optionally the oil recovery formulation or a portion thereof, the sacrificial agent formulation or a portion thereof, and/or gas from the formation 205 through perforations in the second well 203 to deliver the petroleum, and optionally the oil recovery formulation or a portion thereof, the sacrificial agent formulation or a portion thereof, and/or gas, to the second injection/production facility 231.

Alternatively, the mechanism for recovering and producing the petroleum—and optionally the oil recovery formulation or a portion thereof, the sacrificial agent or a portion thereof, and/or gas—from the formation 205 may be comprised of a compressor 234 that may be located in the second injection/production facility 231. The compressor 234 may be fluidly operatively coupled to a gas storage tank 241 via conduit 236, and may compress gas from the gas storage tank for injection into the formation 205 through the second well 203. The compressor may compress the gas to a pressure sufficient to drive production of petroleum—and optionally the oil recovery formulation or a portion thereof, the sacrificial agent formulation or a portion thereof, and/or gas—from the formation via the second well 203, where the appropriate pressure may be determined by conventional methods known to those skilled in the art. The compressed gas may be injected into the formation from a different position on the second well 203 than the well position at which the petroleum—and optionally the oil recovery formulation or a portion thereof, the sacrificial agent formulation or a portion thereof, and/or gas—are produced from the formation, for example, the compressed gas may be injected into the formation at formation portion 207 while petroleum, oil recovery formulation, sacrificial agent formulation, and/or gas are produced from the formation at formation portion 209.

Petroleum, optionally in a mixture with the oil recovery formulation or a portion thereof, the sacrificial agent formulation or a portion thereof, and/or gas may be drawn from the formation 205 as shown by arrows 229 and produced up the second well 203 to the second injection/production facility 231. The petroleum may be separated from the oil recovery formulation or a portion thereof, the sacrificial agent formulation or a portion thereof, and/or gas in a separation unit 235 located in the second injection/production facility 231 and operatively fluidly coupled to the mechanism 233 for producing and recovering petroleum and, optionally, the oil recovery formulation or a portion thereof, the sacrificial agent formulation or a portion thereof, and/or gas, from the formation. The separation unit 235 may be comprised of a conventional liquid-gas separator for separating gas from the petroleum, the oil recovery formulation, and the sacrificial agent formulation; and a conventional hydrocarbon-water separator including a demulsification unit for separating the petroleum from the oil recovery formulation and the sacrificial agent formulation.

The separated produced petroleum may be provided from the separation unit 235 of the second injection/production facility 231 to a petroleum storage tank 237, which may be fluidly operatively coupled to the separation unit 235 of the second injection/production facility by conduit 239. The separated gas, if any, may be provided from the separation unit 235 of the second injection/production facility 231 to the gas storage tank 241, which may be fluidly operatively coupled to the separation unit 235 of the second injection/production facility 231 by conduit 243.

The separated produced oil recovery formulation, optionally including the sacrificial agent formulation or a portion thereof, may be provided from the separation unit 235 of the second injection/production facility 231 to the oil recovery formulation storage unit 215, which may be fluidly operatively coupled to the separation unit 235 of the second injection/production facility 231 by conduit 245. Alternatively, the separated oil recovery formulation, optionally including the sacrificial agent formulation or a portion thereof, may be provided from the separation unit 235 of the second injection/production facility 231 to the injection mechanism 221 via conduit 238 for re-injection into the formation 205 through the first well 201, optionally together with fresh oil recovery formulation, for further mobilization and recovery of petroleum from the formation. Alternatively, the separated oil recovery formulation, optionally including the sacrificial agent formulation or a portion thereof, may be provided from the separation unit 235 to an injection mechanism such as pump 251 in the second injection/production facility 231 via conduit 240 for re-injection into the formation 205 through the second well 203, optionally together with fresh oil recovery formulation.

In an embodiment of a system and a method of the present invention, the first well 201 may be used for injecting the sacrificial agent formulation and subsequently the oil recovery formulation into the formation 205 and the second well 203 may be used to produce petroleum from the formation as described above for a first time period, and the second well 203 may be used for injecting the sacrificial agent formulation and subsequently the oil recovery formulation into the formation 205 to mobilize the petroleum in the formation and drive the mobilized petroleum across the formation to the first well and the first well 201 may be used to produce petroleum from the formation for a second time period, where the second time period is subsequent to the first time period. The second injection/production facility 231 may comprise a mechanism such as pump 251 that is fluidly operatively coupled to the sacrificial agent formulation storage facility 225 by conduit 255 and to the oil recovery formulation storage facility 215 by conduit 253, and optionally fluidly operatively coupled to the separation units 235 and 259 by conduits 240 and 242, respectively, to receive produced sacrificial agent formulation and produced oil recovery formulation therefrom, and that is fluidly operatively coupled to the second well 203 to introduce the sacrificial agent formulation and subsequently the oil recovery formulation into the formation 205 via the second well. The first injection/production facility 217 may comprise a mechanism such as pump 257 or compressor 258 for production of petroleum, and optionally the oil recovery formulation or a portion thereof, the sacrificial agent formulation or a portion thereof, and/or gas from the formation 205 via the first well 201. The first injection/production facility 217 may also include a separation unit 259 for separating produced petroleum, produced oil recovery formulation or a portion thereof, produced sacrificial agent formulation or a portion thereof, and/or gas. The separation unit 259 may be comprised of a conventional liquid-gas separator for separating gas from the produced petroleum, the produced oil recovery formulation, and the produced sacrificial agent formulation; and a conventional hydrocarbon-water separator for separating the produced petroleum from the produced oil recovery formulation or a portion thereof and the produced sacrificial agent formulation or a portion thereof, where the hydrocarbon-water separator may comprise a demulsifier. The separation unit 259 may be fluidly operatively coupled to: the petroleum storage tank 237 by conduit 261 for storage of produced petroleum in the petroleum storage tank; and the gas storage tank 241 by conduit 265 for storage of produced gas in the gas storage tank.

The separation unit 259 may be fluidly operatively coupled to the oil recovery formulation storage facility 215 by conduit 263 for storage of the produced oil recovery formulation, and optionally produced sacrificial agent formulation, in the oil recovery formulation storage facility 215. The separation unit 259 may be fluidly operatively coupled to either the injection mechanism 221 of the first injection/production facility 217 for injecting the produced oil recovery formulation and optionally the produced sacrificial agent formulation into the formation 205 through the first well 201 or the injection mechanism 251 of the second injection/production facility 231 for injecting the produced oil recovery formulation and optionally the produced sacrificial agent formulation into the formation through the second well 203 by conduits 242 and 244, respectively.

The first well 201 may be used for introducing the sacrificial agent formulation and subsequently the oil recovery formulation into the formation 205 and the second well 203 may be used for producing petroleum and, optionally the oil recovery formulation and the sacrificial agent formulation, from the formation for a first time period; then the second well 203 may be used for introducing the sacrificial agent formulation and subsequently the oil recovery formulation into the formation 205 and the first well 201 may be used for producing petroleum, and optionally the oil recovery formulation and the sacrificial agent formulation, from the formation for a second time period; where the first and second time periods comprise a cycle. Multiple cycles may be conducted which include alternating the first well 201 and the second well 203 between introducing the sacrificial agent formulation and subsequently the oil recovery formulation into the formation 205 and producing petroleum, and optionally the oil recovery formulation and the sacrificial agent formulation, from the formation, where one well is introducing and the other is producing for the first time period, and then they are switched for a second time period. A cycle may be from about 12 hours to about 1 year, or from about 3 days to about 6 months, or from about 5 days to about 3 months. In some embodiments, the sacrificial agent formulation may be introduced into the formation at the beginning of a cycle, and an oil recovery formulation may be introduced at the end of the cycle. In some embodiments, the beginning of a cycle may be the first 1% to about 60% of a cycle, or the first 5% to about 50% of a cycle, the first 10% to about 40% of a cycle, and the end may be the remainder of the cycle.

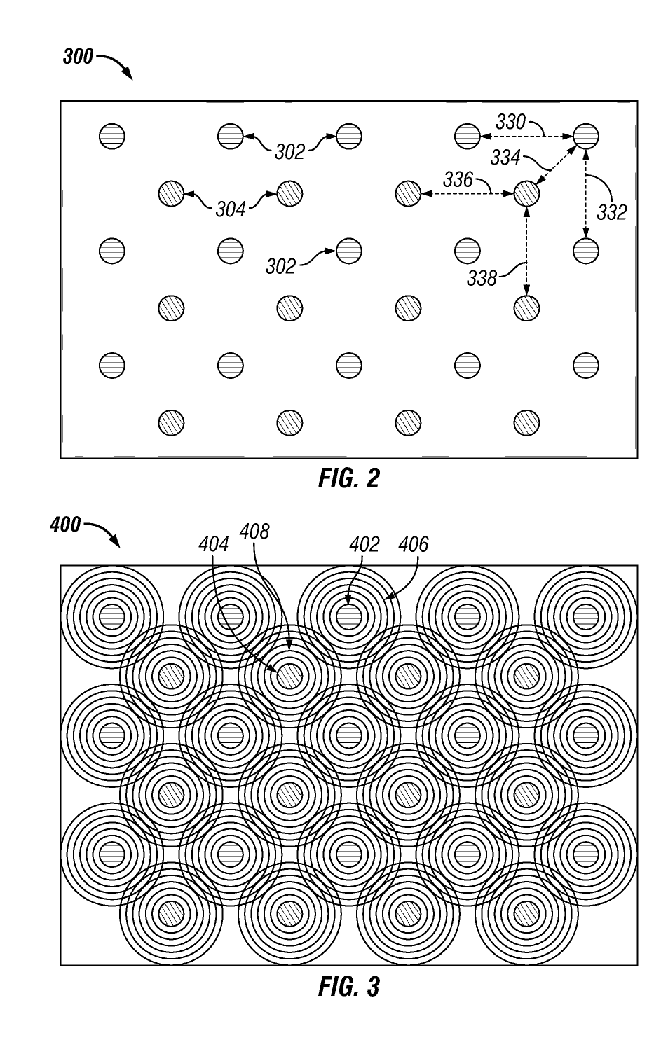

Referring now to FIG. 2, an array of wells 300 is illustrated. Array 300 includes a first well group 302 (denoted by horizontal lines) and a second well group 304 (denoted by diagonal lines). In some embodiments of the system and method of the present invention, the first well of the system and method described above may include multiple first wells depicted as the first well group 302 in the array 300, and the second well of the system and method described above may include multiple second wells depicted as the second well group 304 in the array 300.

Each well in the first well group 302 may be a horizontal distance 330 from an adjacent well in the first well group 302. The horizontal distance 330 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the first well group 302 may be a vertical distance 332 from an adjacent well in the first well group 302. The vertical distance 332 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the second well group 304 may be a horizontal distance 336 from an adjacent well in the second well group 304. The horizontal distance 336 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the second well group 304 may be a vertical distance 338 from an adjacent well in the second well group 304. The vertical distance 338 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be a distance 334 from the adjacent wells in the second well group 304. Each well in the second well group 304 may be a distance 334 from the adjacent wells in first well group 302. The distance 334 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be surrounded by four wells in the second well group 304. Each well in the second well group 304 may be surrounded by four wells in the first well group 302.

In some embodiments, the array of wells 300 may have from about 10 to about 1000 wells, for example from about 5 to about 500 wells in the first well group 302, and from about 5 to about 500 wells in the second well group 304.

In some embodiments, the array of wells 300 may be seen as a top view with first well group 302 and the second well group 304 being vertical wells spaced on a piece of land. In some embodiments, the array of wells 300 may be seen as a cross-sectional side view of the formation with the first well group 302 and the second well group 304 being horizontal wells spaced within the formation.

Referring now to FIG. 3, an array of wells 400 is illustrated. Array 400 includes a first well group 402 (denoted by horizontal lines) and a second well group 404 (denoted by diagonal lines). The array 400 may be an array of wells as described above with respect to array 300 in FIG. 3. In some embodiments of the system and method of the present invention, the first well of the system and method described above may include multiple first wells depicted as the first well group 402 in the array 400, and the second well of the system and method described above may include multiple second wells depicted as the second well group 404 in the array 400.

The sacrificial agent formulation and subsequently the oil recovery formulation may be injected into first well group 402 and petroleum, and optionally the oil recovery formulation and the sacrificial agent formulation, may be recovered and produced from the second well group 404. As illustrated, the sacrificial agent formulation and subsequently the oil recovery formulation may have an injection profile 406, and petroleum, and optionally the oil recovery formulation and the sacrificial agent formulation, may be produced from the second well group 404 having a petroleum recovery profile 408.

The sacrificial agent formulation and subsequently the oil recovery formulation may be injected into the second well group 404 and petroleum, and optionally the oil recovery formulation and the sacrificial agent formulation, may be produced from the first well group 402. As illustrated, the sacrificial agent formulation and subsequently the oil recovery formulation may have an injection profile 408, and petroleum, and optionally the oil recovery formulation and the sacrificial agent formulation, may be produced from the first well group 402 having a petroleum recovery profile 406.

The first well group 402 may be used for injecting the sacrificial agent formulation and subsequently the oil recovery formulation and the second well group 404 may be used for producing petroleum, and optionally the oil recovery formulation and the sacrificial agent formulation, from the formation for a first time period; then second well group 404 may be used for injecting the sacrificial agent formulation and subsequently the oil recovery formulation and the first well group 402 may be used for producing petroleum, and optionally the oil recovery formulation and the sacrificial agent formulation, from the formation for a second time period, where the first and second time periods comprise a cycle. In some embodiments, multiple cycles may be conducted which include alternating first and second well groups 402 and 404 between injecting the sacrificial agent formulation and subsequently the oil recovery formulation and producing petroleum, and optionally the oil recovery formulation and the sacrificial agent formulation, from the formation, where one well group is injecting and the other is producing for a first time period, and then they are switched for a second time period.

To facilitate a better understanding of the present invention, the following examples of certain aspects of some embodiments are given. In no way should the following examples be read to limit, or define, the scope of the invention.

### EXAMPLES

### Example 1

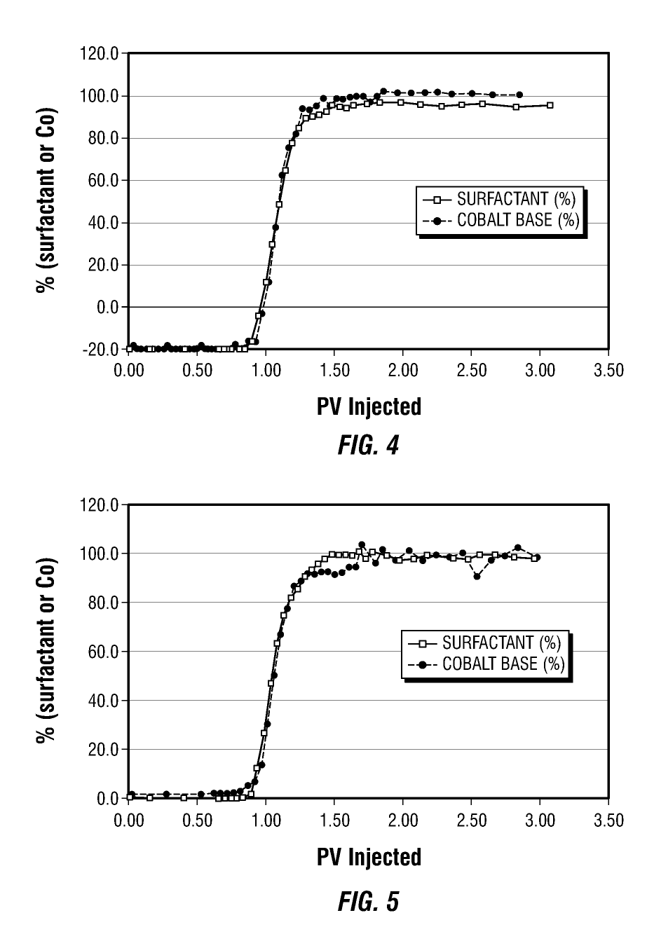

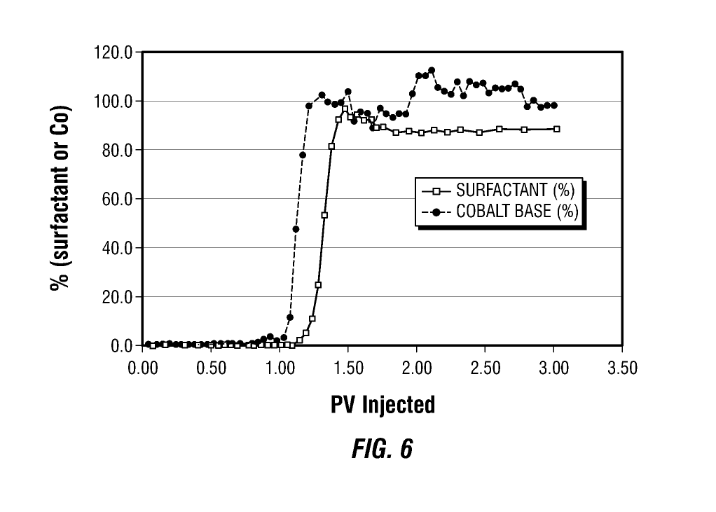

The effectiveness of erythorbic acid as a sacrificial agent for inhibiting surfactant adsorption in sandstone was determined when contacting the sandstone with erythorbic acid prior to contacting the sandstone with a surfactant. Erythorbic acid was added at 0.05 wt. % concentration to an aqueous formation brine containing 14.8 g/L NaCl, 0.043 g/L CaCl₂, and 0.073 g/L MgCl₂ to form a sacrificial agent formulation. The sacrificial agent formulation was then passed through a Boise sandstone core until a negative REDOX potential was observed in the effluent. An oil recovery formulation was formulated by adding 2 wt. % sodium carbonate, 0.48 wt. % of a C₁₂₋₁₃-7PO (propylene oxide) sulfate surfactant, 0.12 wt. % of a C₁₅₋₁₈ internal olefin sulfonate surfactant, and 10 ppm of a non-interacting cobalt tracer to an aqueous brine containing 1.75 wt. % NaCl. The oil recovery formulation was then passed through the Boise sandstone core that had been treated with the sacrificial agent formulation. Retention of the surfactant was measured both in the presence and in the absence of 0.5 wt. % of a secondary butyl alcohol co-solvent. A control test was performed in which the core was pre-flushed to a reducing state with a like pre-flush aqueous fluid containing sodium dithionite instead of the erythorbic acid, followed by passing the oil recovery formulation through the core. FIGS. 4 and 5 show illustrative retention plots of various fluid components through the core after a pre-flush with the erythorbic acid sacrificial agent formulation. The data of FIG. 4 was obtained in the absence of the secondary butyl alcohol co-solvent in the oil recovery formulation, and the data of FIG. 5 was obtained in the presence of a secondary butyl alcohol co-solvent in the oil recovery formulation. As shown in FIGS. 4 and 5, essentially identical results were obtained in the presence and absence of the secondary butyl alcohol co-solvent, and virtually no retention of the surfactant was observed. FIG. 6 shows an illustrative retention plot of various fluid components after pre-flush of the core with a sodium dithionite-containing fluid instead of an erythorbic acid sacrificial agent formulation. As shown in FIG. 6, significant retention of the surfactant was observed when the core was reduced with sodium dithionite instead of being treated with an erythorbic sacrificial agent formulation. The degree of surfactant retention observed in FIG. 6 corresponded to 20 mg of retained surfactant per 100 g of core.

### Example 2

The effectiveness of ascorbic acid, glucose (monohydrate), EDTA, sodium acetate, and erythorbic acid as sacrificial agents for inhibiting surfactant adsorption in sandstone was determined when used in a pre-flush solution prior to contacting sandstone with a surfactant. Four pre-flush solutions were prepared by mixing a brine solution containing 14.8 g/L NaCl, 0.043 g/L CaCl₂.2H₂O, and 0.073 g/L MgCl₂6.H₂O with 500 ppm of ascorbic acid, glucose (monohydrate), EDTA, and erythorbic acid, respectively, as a sacrificial agent. A fifth pre-flush solution was prepared by mixing the same brine solution with 183 ppm of sodium acetate as a sacrificial agent. For each of the pre-flush solutions, a Bandera brown sandstone core was flushed with CO₂ to remove air in the core and then was saturated with a brine solution containing 14.8 g/L NaCl, 0.043 g/L CaCl₂.2H₂O, and 0.073 g/L MgCl₂.6H₂O. The core was then injected with 3.5 pore volumes of the pre-flush solution followed by injection of a surfactant slug of 3 pore volumes, where the surfactant slug contained 0.48 wt. % of a C₁₂₋₁₃7PO (propylene oxide) sulfate surfactant, 0.12 wt. % of a C₁₅₋₁₈ internal olefin sulfonate surfactant, and 10 ppm of a non-interacting cobalt tracer in an aqueous brine containing 3.45 wt. % NaCl. After the injection of the surfactant slug, the core was injected with 3 pore volumes of an aqueous brine containing 3.45 wt. % NaCl. A control was also conducted where a Bandera brown sandstone core saturated with a brine solution containing 14.8 g/L NaCl, 0.043 g/L CaCl₂.2H₂O, and 0.073 g/L MgCl₂.6H₂O was injected with 3 pore volumes of the surfactant slug as described above followed by 3 pore volumes of aqueous brine containing 3.45 wt. % NaCl with no injection of a pre-flush solution.

Retention of the surfactant in the core was measured by calculating the difference in pore volumes after injection of the surfactant between observed cobalt tracer elution (50%) from the core and the observed surfactant elution (50%) from the core. The calculated surfactant lag and corresponding calculated amount of surfactant adsorbed to the core (wt./wt.) for each pre-flush solution and the control is shown in Table 1 below.

TABLE 1

| Preflush | Surfactant lag (PV) | Adsorption (mg/100 g core) |
|---|---|---|
| Control (no pre-flush) | 1.35 | 97 |
| Erythorbic acid | 0.91 | 54 |
| Ascorbic acid | 0.79 | 51 |
| Glucose | 1.18 | 77 |
| EDTA | 1.16 | 77 |
| Na-acetate | 1.24 | 81 |

As shown in Table 1, all of the sacrificial agent pre-flush solutions showed a positive effect for reducing surfactant retention in the core relative to the control.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. While systems and methods are described in terms of “comprising,” “containing,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from a to b,” or, equivalently, “from a-b”) disclosed herein is to be understood to set forth every number and range encompassed within the broader range of values. Whenever a numerical range having a specific lower limit only, a specific upper limit only, or a specific upper limit and a specific lower limit is disclosed, the range also includes any numerical value “about” the specified lower limit and/or the specified upper limit. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces.

What is claimed is:

1. A method for producing oil, comprising:
providing a sacrificial agent formulation comprising a fluid and a sacrificial agent dispersed in the fluid, wherein the sacrificial agent is selected from the group consisting of a compound comprising a single carboxylic acid, a single carboxylic acid derivative, or a single carboxylate salt; a compound comprising a phenolic group, a thiol group, a sulfonamide group, or a salt thereof that lacks a carboxylic acid group or a salt thereof and lacks a sulfonic acid group or a salt thereof; a compound having a molecular weight of 1000 or less and comprising one or more hydroxyl groups; and mixtures thereof;
introducing the sacrificial agent formulation into a petroleum-bearing formation;
contacting the sacrificial agent formulation with the petroleum-bearing formation;
introducing an oil recovery formulation comprising a surfactant into the petroleum-bearing formation subsequent to introducing the sacrificial agent formulation into the formation;
contacting the oil recovery formulation with petroleum in the petroleum-bearing formation; and
producing petroleum from the petroleum-bearing formation after introducing the oil recovery formulation into the petroleum-bearing formation.

2. The method of claim 1, wherein the oil recovery formulation is introduced into the formation at the same location as the sacrificial agent formulation.

3. The method of claim 1, wherein the petroleum-bearing formation is a subterranean formation.

4. The method of claim 3, wherein the sacrificial agent formulation and the oil recovery formulation are introduced into the formation via a first well and the petroleum is produced via a second well.

5. The method of claim 4, further comprising producing at least a portion of the oil recovery formulation from the second well.

6. The method of claim 5, further comprising introducing at least a portion of the produced oil recovery formulation into the subterranean formation.

7. The method of claim 1, wherein the oil recovery formulation further comprises an alkali and a polymer.

8. The method of claim 7, wherein the polymer is selected from the group consisting of polyacrylamides, partially hydrolyzed polyacrylamides, polyacrylates, ethylenic co-polymers, biopolymers, carboxymethylcelloluses, polyvinyl alcohols, polystyrene sulfonates, polyvinylpyrrolidones, AMPS (2-acrylamide-methyl propane sulfonate), and combinations thereof and the alkali is selected from the group consisting of lithium hydroxide, sodium hydroxide, potassium hydroxide, lithium carbonate, sodium carbonate, potassium carbonate, lithium bicarbonate, sodium bicarbonate, potassium bicarbonate, lithium silicate, lithium phosphate, sodium silicate, sodium phosphate, potassium silicate, and potassium phosphate, and mixtures thereof.

9. The method of claim 1, wherein the sacrificial agent comprises a monohydroxycarboxylic acid, a dihydroxycarboxylic acid, a trihydroxycarboxylic acid, a tetrahydroxycarboxylic acid, a pentahydroxycarboxylic acid, a salt thereof, or any combination thereof.

10. The method of claim 1, wherein the sacrificial agent comprises 10 carbons or less.

11. The method of claim 1, wherein the sacrificial agent comprises an oxidizable functional group.

12. The method of claim 11, further comprising oxidizing the sacrificial agent while contacting the petroleum-bearing formation.

13. The method of claim 1, wherein the sacrificial agent comprises an enol.

14. The method of claim 1, wherein the sacrificial agent comprises a reductone.

15. The method of claim 14, wherein the sacrificial agent further comprises a carboxylic acid derivative selected from the group consisting of an ester and an amide.

16. The method of claim 15, wherein the sacrificial agent comprises a lactone or a lactam.

17. The method of claim 1, wherein the sacrificial agent comprises a carbohydrate selected from the group consisting of a monosaccharide, a disaccharide, a trisaccharide, a tetrasaccharide, a pentasaccharide, or any combination thereof, wherein the carbohydrate comprises at least one reducing sugar.

18. The method of claim 1, wherein the sacrificial agent is selected from the group consisting of erythorbic acid, ascorbic acid, dehydroerythorbic acid, dehydroascorbic acid, a derivative thereof, or a salt thereof, and any combination thereof.

19. The method of claim 1, wherein the sacrificial agent comprises from 0.001 wt. % to 5 wt. %, or from 0.01 wt. % to 0.5 wt. % of the sacrificial agent formulation.

20. The method of claim 1, wherein the surfactant is an anionic surfactant.

21. The method of claim 20, wherein the surfactant is selected from the group consisting of an alpha olefin sulfonate compound, an internal olefin sulfonate compound, a branched alkyl benzene sulfonate compound, a propylene oxide sulfate compound, or a blend thereof.

22. The method of claim 1, wherein the surfactant comprises from 0.05 wt. % to 5 wt. %, or from 0.2 wt. % to 1 wt. % of the oil recovery formulation.

23. The method of claim 1, wherein the fluid of the sacrificial agent formulation is water or an aqueous brine.

24. The method of claim 1, wherein the fluid of the oil recovery formulation is water or an aqueous brine.

25. A system, comprising:
a sacrificial agent formulation comprising a fluid and a sacrificial agent dispersed the fluid, wherein the sacrificial agent is selected from the group consisting of a compound comprising a single carboxylic acid, a single carboxylic acid derivative, or a single carboxylate salt; a compound comprising a phenolic group, a thiol group, a sulfonamide group, or a salt thereof that lacks a carboxylic acid group or a salt thereof and lacks a sulfonic acid group or a salt thereof; a compound having a molecular weight of 1000 or less and comprising one or more hydroxyl groups; and mixtures thereof
an oil recovery formulation comprising a fluid and a surfactant dispersed in the fluid;
a petroleum-bearing formation;
a mechanism for introducing the sacrificial agent formulation into the petroleum-bearing formation;
a mechanism for introducing the oil recovery formulation into the petroleum-bearing formation subsequent to introduction of the sacrificial agent formulation into the formation; and
a mechanism for producing petroleum from the petroleum-bearing formation subsequent to introduction of the oil recovery formulation into the formation.

26. The system of claim 25, wherein the petroleum-bearing formation is a subterranean formation.

27. The system of claim 26, wherein the mechanism for introducing the sacrificial agent formulation into the formation is located at a first well, wherein the first well extends into the subterranean formation.

28. The system of claim 27, wherein the mechanism for introducing the oil recovery formulation into the formation is located at a first well, wherein the first well extends into the subterranean formation.

29. The method of claim 28, wherein the mechanism for producing the petroleum from the formation is located at a second well, wherein the second well extends into the subterranean formation.

30. The system of claim 25, wherein the sacrificial agent is selected from the group consisting of erythorbic acid, ascorbic acid, dehydroerythorbic acid, dehydroascorbic acid, a salt thereof, and any combination thereof.

31. The system of claim 25, wherein the surfactant is an anionic surfactant.

32. The system of claim 25, wherein the oil recovery formulation further comprises a polymer.

33. The system of claim 32, wherein the polymer is selected from the group consisting of polyacrylamides, partially hydrolyzed polyacrylamides, polyacrylates, ethylenic co-polymers, biopolymers, carboxymethylcelloluses, polyvinyl alcohols, polystyrene sulfonates, polyvinylpyrrolidones, AMPS (2-acrylamide-methyl propane sulfonate), and combinations thereof.

34. The system of claim 32, wherein the oil recovery formulation further comprises an alkali selected from the group consisting of lithium hydroxide, sodium hydroxide, potassium hydroxide, lithium carbonate, sodium carbonate, potassium carbonate, lithium bicarbonate, sodium bicarbonate, potassium bicarbonate, lithium silicate, lithium phosphate, sodium silicate, sodium phosphate, potassium silicate, and potassium phosphate, and mixtures thereof.
